(19) United States
(12) Patent Application Publication
(10) Pub. No.: US 2012/0320801 A1
(43) Pub. Date: Dec. 20, 2012

(54) Nodes For Improved Credit Validation

(75) Inventors: Yong Yang, Molndal (SE); John Stenfelt, Goteborg (SE)

(73) Assignee: Telefonaktiebolaget L M Ericsson (publ), Stockholm (SE)

(21) Appl. No.: 13/002,610

(22) PCT Filed: Dec. 30, 2010
(86) PCT No.: PCT/EP10/70906

§ 371 Date: Jan. 4, 2011

Related U.S. Application Data
(60) Provisional application No. 61/304,937, filed on Feb. 16, 2010.

(51) Int. Cl. H04W 4/24

(52) U.S. Cl. 370/259

(57) ABSTRACT

A Policy and Charging Rules Function node, a PCRF node (120), for a communications system, with an interface (Sy) towards an Online Charging System node, an OCS node (115), in the system. The PCRF node can transmit an inquiry to the OCS over said interface (Sy) regarding a credit validation for a service requested by an end user. The PCRF node is arranged to receive a reply from the OCS to said enquiry. Also disclosed is an OCS node (115), in a communications system equipped with an interface (Sy) towards a PCRF node (120) in the system (100), the OCS node (115) arranged to receive an inquiry from the PCRF node over said interface (Sy) regarding a credit validation for a service which has been requested by an end user, the OCS node (115) also being arranged to establish and transmit a reply to the PCRF node (120).

### TECHNICAL FIELD

The present invention discloses nodes for improved credit validation in a communications system.

### BACKGROUND

The Policy and Charging Control, PCC, architecture was introduced in 3GPP Rel-7, and has been further evolved in 3GPP Rel8 and Rel9. It provides operators with advanced tools for service-aware QoS and charging control.

For 3GPP Rel-10, there is currently a Study Item for Policy Enhancements that investigates various functional additions to the already existing architecture. Currently there are 4 key issues under investigation. One of those key issues is called “QoS and gating control based on spending limits”. This key issues looks into the case when the QoS (bandwidth) of an ongoing session must be throttled due to the fact that the user has reached some form of credit related limit. One example might be that the user is roaming (data services while roaming is often expensive and charged per Megabyte) and has a pre-defined safety limit of e.g. 50 Euros where the bandwidth should be set to a minimum until the user has been informed and once again has agreed to be charged for another 50 Euros.

In the 3GPP PCC architecture as defined in 3GPP TS 23.203, an IP-CAN session is an association between a UE represented by an IPv4 and/or an IPv6 address, and UE identity information, if available, and a PDN represented by a PDN ID (e.g. an APN). An IP-CAN session incorporates one or more IP-CAN bearers. Support for multiple IP-CAN bearers per IP-CAN session is IP-CAN specific. Further on an IP-CAN session exists as long as UE IP addresses are established and announced to the IP network. There are different IP-CAN types defined in the current PCC standard, for example 3GPP-EPS, 3GPP-GPRS, 3GPP2, xDSL, WiMAX and so on.

In particular, 3GPP TS 23.401 describes a particular case of the PCC network architecture of 3GPP TS 23.203 for the—so called—“3GPP accesses” (GERAN/UTRAN/E-UTRAN), also referred as “3GPP-EPS”

“IP-CAN domain” represents a set of access network entities which are depended on IP-CAN type, i.e. IP connectivity access type, e.g. for 3GPP EPS, IP-CAN domain includes eNodeB, MME, SGW, PGW etc.

The Evolved Packet System (EPS) applies the PCC framework as defined in 3GPP TS 23.203 for QoS policy and charging control. PCC functionality is present in the AF, PCEF and PCRF.

An EPS needs to support both PCEF and PCRF functionality to enable dynamic policy and charging control by means of installation of PCC rules on the IP-CAN session based on user (i.e. UE user) and service. For example, in case of 3GPP-EPS network, during E-UTRAN initial attach procedure of a UE, the PCEF initiates a diameter session for the PDN connection between PCEF and PCRF. In addition in case of PMIP based S5/S8 interface, the BBERF must also setup a diameter session for that PDN connection of the UE.

It is the same for GPRS: the GPRS IP-CAN incorporates GPRS over GERAN and UTRAN and the PDP context is used to provide an information transmission path of defined capacity (QoS) as an IP-CAN bearer. During IP-CAN session establishment, i.e. Primary PDP Context activation procedure, the PCEF needs to setup a diameter session for the IP-CAN session between PCEF and PCRF.

According to the current PCC architecture, after the UE has setup at least one PDN connection, for those AF controlled services such as IMS Voice Over IP call, no matter it is originating call or terminating call, the AF will send the media information including the QoS requirement (description) for the corresponding service to the PCRF. Once the PCRF receives such session and media information, it will based on the locally configured policies, together with User subscription and the information about the current PDN connection such as user location, calendar time, compile PCC rules which includes both Policy and the charging related information. For the charging related information, the PCRF may specify whether online charging or offline charging shall apply to a service. The PCC rules are then supplied to the PCEF over the Gx interface, i.e. the interface between the PCRF and the PCEF.

Once the PCEF (GGSN or PDN-GW) receives the PCC rules, according to 3GPP TS23.401 and 3GPP TS23.060, the PCEF should allocate resources in the network by setting up a new dedicated EPS bearer for LTE or setting up a network initiated Secondary PDP contexts. In case the UE is a prepaid subscriber, the PCEF must contact OCS to request credit for the requested service. Such a request maybe rejected by OCS due to various reason for example if Credit is exhausted (or close to being exhausted) for this UE, or for this Rating Group, or for this Service. If this happened the corresponding setting up Dedicated Bearer or Secondary PDP Context will fail and the PCEF must trigger a PCC rule error handling as specified in 3GPP TS29.212 to inform PCRF the corresponding PCC rule is not possible be enforced in the PCEF which implies additional signaling traffic over Gx is needed.

Consequently all the signaling messages (procedures) happened over Gx and Gy interface, especially signaling message within the EPS/GPRS network, e.g. to setup a dedicated bearer for this AF controlled service are in vain.

### SUMMARY

It is a purpose of the present invention to provide an improvement on the procedure which is used when an end user requests a new service or a modification in an existing (i.e. session established) service.

This purpose is met by the present invention in that it discloses a Policy and Charging Rules Function node, a PCRF node, for a communications system. The PCRF node of the invention is equipped with an interface towards an Online Charging System node, an OCS node, in the communications system, and the PCRF node is arranged to transmit an inquiry to the OCS over said interface regarding a credit validation for a service which has been requested by an end user in the communications system. The PCRF node is also arranged to receive a reply from the OCS to said enquiry.

In some embodiments, the PCRF node of the invention is arranged to receive the request for a service from an end user via a node for Policy and Charging Enforcement Function, a PCEF node, in the system.

In some embodiments, the PCRF node of the invention is arranged to receive the request for a service from an end user via an Application Function, an AF, in the system.

In some embodiments, the PCRF node of the invention is arranged to receive the reply from the OCS node as a positive reply which indicates that the end user has sufficient credit for the requested service or as a negative reply which indicates that the end user does not have sufficient credit for the requested service.

In some embodiments, the PCRF node of the invention is arranged to either authorize the service for the end user or to send a reject message for the requested service to the AF or to the PCEF node depending on if the reply from the OCS node is positive or negative.

In some embodiments of the PCRF node of the invention, the inquiry comprises one or more of the following:
The ID of the end user,
The ID of the Packet Data Network, the PDN, of the end user,
The rating group of the requested service,
The ID of the requested service.

In some embodiments of the PCRF node of the invention, the PCRF node is also equipped with an interface towards a Policy and Charging Enforcement Function node, a PCEF node, in the system, and the PCRF node is arranged to use the interface with the PCEF node to provide the PCEF node with new or updated Policy and Charging Control, PCC, rules for an end user in the system, based on the received replies from the OCS.

The invention also discloses an Online Charging System node, an OCS node, in a communications system. The OCS node of the invention is equipped with an interface towards a Policy and Charging Rules Function node, a PCRF node in the system, and the OCS node is arranged to receive an inquiry from the PCRF node over said interface regarding a credit validation for a service which has been requested by an end user in the communications system. The OCS node is also arranged to establish and transmit a reply to the PCRF node to said enquiry.

In some embodiments, the OCS node of the invention is arranged to transmit said reply as a positive reply which indicates that the end user has sufficient credit for the requested service or as a negative reply which indicates that the end user does not have sufficient credit for the requested service.

### BRIEF DESCRIPTION OF THE DRAWINGS

The invention will be described in more detail in the following, with reference to the appended drawings, in which

FIG. 1 shows an overview of a system in which the invention is applied, and

FIG. 2 shows events in parts of the system of FIG. 1, and

FIG. 3 shows a first event diagram in which the invention is used, and

FIG. 4 shows a second event diagram in which the invention is used.

### DETAILED DESCRIPTION

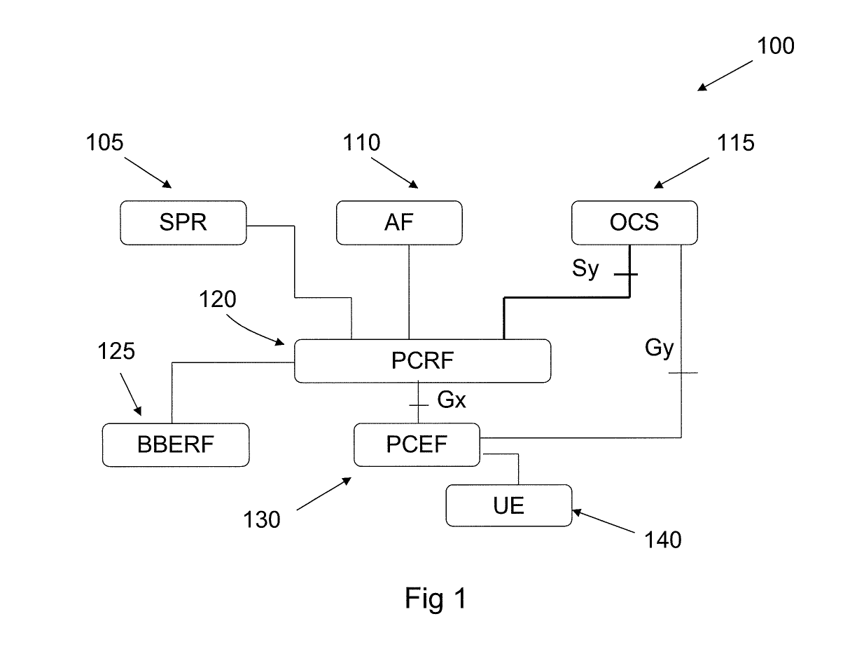

FIG. 1 shows an overview of a communications system 100 in which the invention is applied. The invention will be described by means of the system 100 in FIG. 1, by means of terminology which is taken from the 3GPP project. It should however be emphasized that the invention is also applicable within systems which are “wire bound”, i.e. system which use landlines.

As shown in FIG. 1, the system 100 comprises the following nodes or components:
AF, 110, Application Function,
BBERF, 125, Bearer Binding Event Reporting Function,
OCS, 115, Online Charging System,
PCEF, 130, Policy and Charging Enforcement Function,
PCRF, 120, Policy and Charging Rules Function,
SPR, 105, Solution Profile Repository
UE, 140, User Equipment, also alternatively referred to as “end user”.

As is also shown in FIG. 1, in the system 100 there are interfaces between some of the nodes or components. Thus, between the PCEF 130 and the PCRF 120 there is the so called Gx interface, and between the PCEF 130 and the OCS 115, there is the so called Gy interface. These interfaces are known to those skilled in the art, and will therefore not be described in further detail here.

The present invention proposes opening up an interface between the OCS 115 and the PCRF 120, in addition to the existing interfaces in the system 100. The proposed interface (sometimes also referred to as a “reference point”) between the OCS 115 and the PCRF 120 is labeled Sy interface, and is shown in bold lines in FIG. 1, in order to facilitate for the reader.

The present invention provides a mechanism which allows the PCRF to consult the OCS to make a Credit validation for requested services and network resources over the Sy reference point before making a policy decision for an AF controlled service or for a service requested by the end user via the PCEF node for which the subscriber is to be charged using online charging (i.e. using a pre-paid account). If the Sy credit validation from the OCS either fails or indicate insufficient credit level the PCRF can immediately reject the AF or PCEF request or e.g. downgrade the requested QoS. By doing this PCC signaling can be optimized and the unnecessary setup of network resources can be avoided.

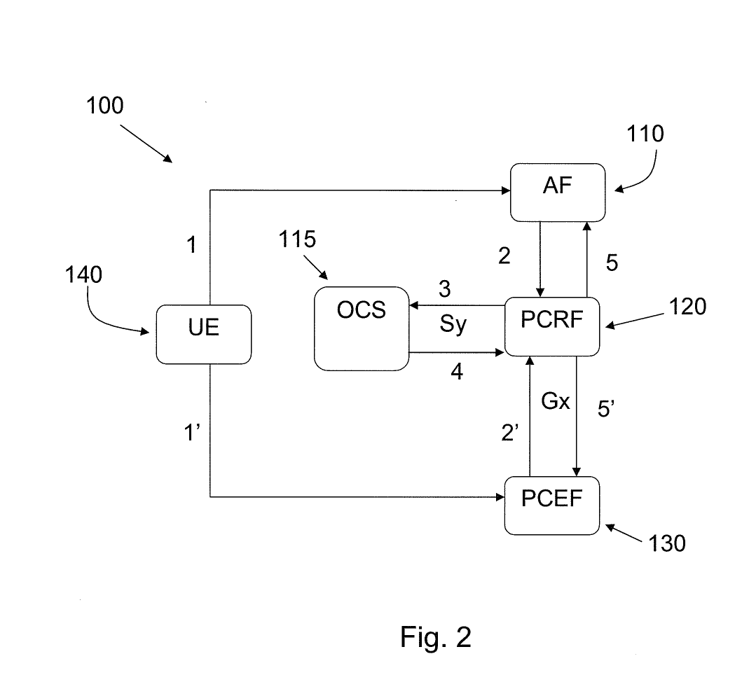

FIG. 2 shows parts of the system 100 from FIG. 1, and also shows events and their alternative events, illustrated by means of numbered arrows, which the invention aims at facilitating. An event and its corresponding alternative event are indicated in FIG. 2 by means of an integer, e.g. N, and the alternative to event N is then indicated as N′. The alternatives are due to the fact that a UE can request a service from a PCRF node either via an AF (Application Function) or via a PCEF node. Events 3 and 4 in FIG. 2 are not indicated as alternatives in FIG. 2, since those events are identical in both cases.

The components shown in FIG. 2 are also present in FIG. 1, and will thus not be explained again here. Instead, the events and the alternative events illustrated in FIG. 2 will be explained here, with reference to the numbered arrows in FIG. 2:

1. An end user, a UE 140, requests the use of a service from the PCRF node 120. This is done via an Application Function, AF 110.

2. The AF 110 forwards the request to the PCRF 120.

3. The PCRF 120 inquires about the UE's credit for the requested service with the OCS node 115.

4. The OCS node 115 responds to the credit request from the PCRF 120. The response can be positive or negative, i.e. as a positive reply which indicates that the UE (also referred as the end user) has sufficient credit for the requested service or as a negative reply which indicates that the UE does not have sufficient credit for the requested service.

5. The PCRF 120 sends a “reject” or “authorize” message to the AF 110, depending on the nature (negative/positive) of the reply from the OCS 115.

Alternatively, the UE 140 requests a service from the PCRF node 120 via the PCEF node 130, as follows:

1′. An end user, a UE 140, requests the use of a service from the PCRF node 120. This is done via a PCEF node 130.

2′. The PCEF node 130 forwards the request to the PCRF 120.

3. The PCRF 120 inquires about the UE's credit for the requested service with the OCS node 115.

4. The OCS node 115 responds to the credit request from the PCRF 120. The response can be positive or negative, i.e. as a positive reply which indicates that the UE (also referred as the end user) has sufficient credit for the requested service or as a negative reply which indicates that the UE does not have sufficient credit for the requested service.

5′. The PCRF 120 sends a “reject” or “authorize” message to the PCEF node 130, depending on the nature (negative/positive) of the reply from the OCS 115.

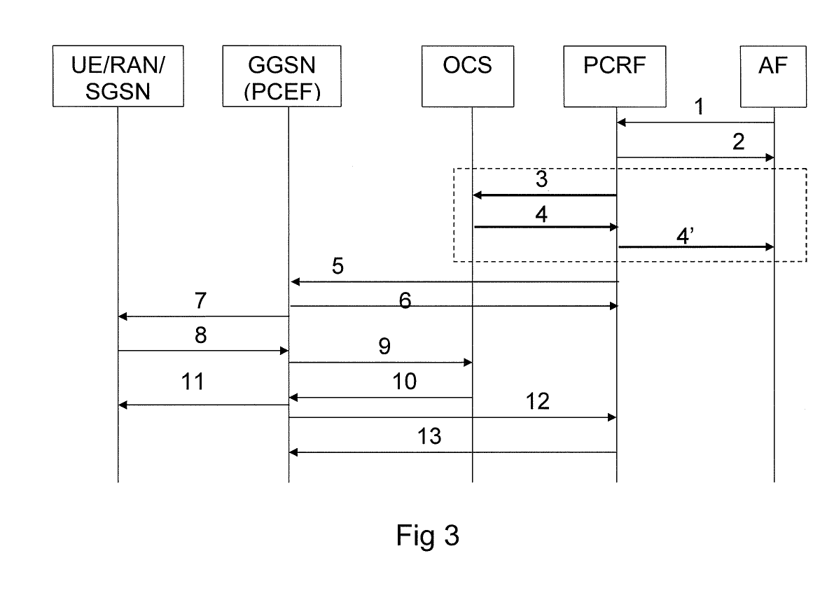

FIG. 3 is a diagram which shows the use case or signaling flow when a PCRF receives the request for a service from an end user via an Application Function, an AF, in the system, starting from when the AF opens an Rx Diameter session with the PCRF for the AF session using an AA-Request command including the service information (media information). In the example, use is made of 2G/3G access and an SGSN together with a GGSN serving as the PCEF. The numbers of the arrows in FIG. 3 indicate the following:

1. The AF provides/revokes service information to the PCRF due to AF session signalling. The AF may subscribe at this point to notification of bearer level events related to the service information.
NOTE: For the PCRF to generate the applicable events, the PCRF instructs the PCEF to report events related to the corresponding PCC rules. Such events are not shown in this sequence diagram.

2. The PCRF stores the service information if available, and responds with an Acknowledgement to the AF.

3. PCRF sends an inquiry to OCS and asks about the credit status and other information related to the end user subscription, for example the subscription type, e.g. “premier level” of the end user (i.e. the UE) in case Online charging is needed.

4. OCS validates the charging control. The OCS may also in some embodiments indicate other information related to the end user subscription, for example the subscription type, e.g. “premier level”, of the end user (i.e. the UE) which has an impact on the QoS.

4′. If the OCS sends a negative response to the PCRF, i.e. a response which indicates that the end user has insufficient credit for the requested service, the PCRF sends a “reject” message to the AF, rejecting the requested service for the end user.

The following steps are only applicable if the OCS sends a positive response to the PCRF, i.e. an “authorize” response which indicates that end user has sufficient credit for the requested service.

5. The PCRF makes the authorization and policy decision, and sends the message Policy and Charging Rules Provision (PCC Rules, Event Trigger, Event Report) to the PCEF.

6. The PCEF acknowledges the receiving of PCC rule.

7. The PCEF initiates the secondary PDP Context activation by sending the GTPv1 message “Initiate PDP Context Activation Request” to the SGSN.

8. The SGSN sends the message Create PDP Context Request to set up the secondary PDP Context.

9. The GGSN (PCEF) may now request credit for new charging keys from the OCS and/or shall return the remaining credit for charging keys no longer active to the OCS if online charging is applicable.

10. If the OCS was involved, the OCS provides the credit information to the PCEF, and/or acknowledges the credit report.

11. If the OCS grants the quota, i.e. the credit is available, the secondary PDP Context activation will be accepted. But if the OCS does NOT grant the quota, the PCEF needs to reject the secondary PDP context activation.

12. The PCEF (GGSN) needs to send a new CCR to report that the corresponding PCC rule failed to be enforced in PCEF and it is inactive.

13. The PCRF needs to acknowledge the report.

NOTE: The above signalling diagram is based on a particular implementation. In the 3GPP specification, steps 9 and 10 can actually take place before step 7.

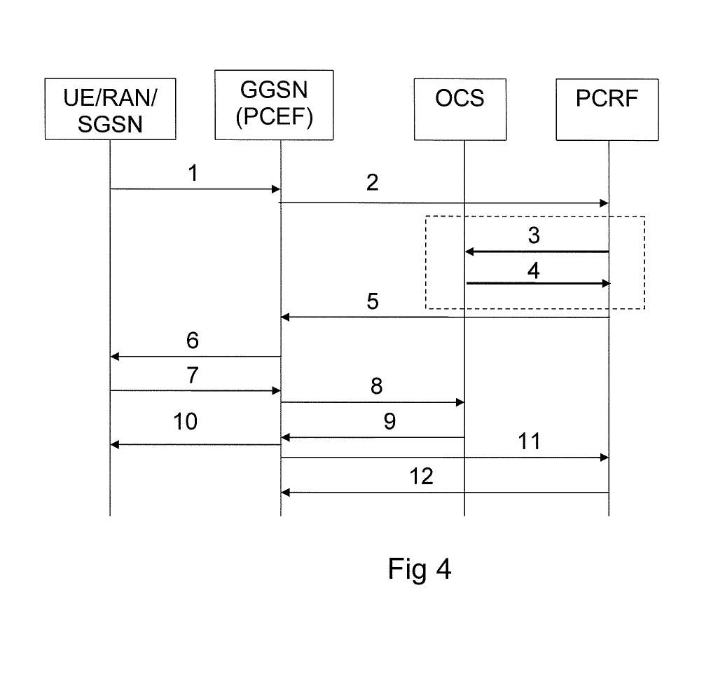

FIG. 4 is a diagram which shows the use case or signaling flow when the PCRF receives the request for a service from an end user via a PCEF node in the system, starting from when the UE (i.e. the end user) requests a service from the PCEF, including the service specific information. In the example, use is made of 2G/3G access and an SGSN together with a GGSN serving as the PCEF. The numbers of the arrows of FIG. 4 indicate the following:

1. The UE (end user) requests a service via the access network to the PCEF.

2. This triggers the PCEF to send the message “Indication of IP-CAN session modification” to the PCRF, including the requested service information.

3. The PCRF sends an inquiry to the OCS asking about the credit status and other information related to the end user subscription, for example the subscription type, e.g. “premier level ” of the end user (i.e. the UE) in case Online charging is needed.

4. OCS validates the charging control. The OCS may also in some embodiments indicate other information related to the end user subscription, for example the subscription type, e.g. “premier level”, of the end user (i.e. the UE) which has an impact on the QoS.

5. If the OCS sends a positive response to the PCRF, i.e. a response which indicates that the UE has sufficient credit for the requested service, then the PCRF makes the authorization and policy decision and sends the message Acknowledge IP CAN session modification (PCC Rules, Event Trigger, Event Report) to the PCEF.

If, instead, the OCS sends a negative response to the PCRF, i.e. a response which indicates that the end user has insufficient credit for the requested service, the PCRF sends an Acknowledge IP CAN session modification message to the PCEF, rejecting the requested service for the end user.

6. If the service request was accepted by the PCRF, i.e. the PCEF received PCC Rules for the requested service(s) in step 5, the PCEF initiates the secondary PDP Context activation by sending the GTPv1 message “Initiate PDP Context Activation Request” to the SGSN.

If, instead, the service request was rejected by the PCRF in step 5, the PCEF rejects the request from the UE (end user) received in step 1. In this case, the events in FIG. 4 then terminate here, i.e. with this step.

7. The SGSN sends the message Create PDP Context Request to set up the secondary PDP Context.

8. The GGSN (PCEF) may now request credit for new charging keys from the OCS and/or shall return the remaining credit for charging keys no longer active to the OCS if online charging is applicable.

9. If the OCS was involved, the OCS provides the credit information to the PCEF, and/or acknowledges the credit report.

10. If the OCS grants the quota, i.e. the credit is available, the secondary PDP Context activation will be accepted. But if the OCS does not grant the quota, the PCEF needs to reject the secondary PDP context activation.

11. The PCEF (GGSN) needs to send a new Credit Control Request, CCR, to report that the corresponding PCC rule could not be enforced in PCEF and it is inactive.

12. The PCRF acknowledges the report to the PCEF.

NOTE: The above signalling diagram is based on a particular implementation. In the 3GPP specification, steps 8 and 9 can actually take place before step 6.

Appended Functionality to Sy Reference Point

According to the present invention, the Sy interface or reference point is also used by PCRF to enquire OCS to make credit validation for those AF controlled services and services that are requested by the end user via the PCEF node. (This is needed to avoid unnecessary signaling traffic over Gx, Gy interfaces and in the 3GPP network (EPS or GPRS) due to a credit control which indicates insufficient credit for a requested service on establishing a dedicated bearer which is used for an AF controlled service. Considering an UE may have multiple PDN connections towards different PDNs (different GGSN), which credit situation for a UE is rather dynamically changed, though different PCEF may select the same PCRF and the same OCS based on the UE's IMSI.

Appended PCRF Functionality

The PCRF receives session and media related information from the AF and informs AF of traffic plane events. The PCRF may also receive service requests from the UE (end user) via the PCEF.

The PCRF may check that the service information provided by the AF or PCEF is consistent with the operator defined policy rules before storing the service information. The service information shall be used to derive the QoS for the service. The PCRF may reject the request received from the AF and as a result the PCRF shall indicate, in the response to the AF, the service information that can be accepted by the PCRF. The PCRF may also reject a service request from a UE (end user) via PCEF.

The PCRF may use the subscription information as basis for the policy and charging control decisions. The subscription information may apply for both session based and non-session based services. The subscription specific information for each service may contain e.g. max QoS class and max bit rate. In case it is online charging subscriber or preferred online charged service, PCRF shall contact OCS via Sy reference point to get the credit availability (validation). In case the PCRF receives a negative answer from OCS, it can/shall directly reject the AF or PCEF request.

If the AF requests it, the PCRF shall report IP-CAN session events (including bearer events and events on AF signalling transport) to the AF via the Rx reference point or interface.

The PCRF PCC/QoS Rule decisions may be based on one or more of the following:
the session and media related information obtained from the AF via the Rx reference point;
The service information for a UE requested service is obtained from the PCEF via the Gx reference point.
the bearer and subscriber related information obtained from the PCEF over the Gx reference point or interface;
the bearer and subscriber related information obtained from the BBERF over the Gxx reference point or interface;
subscriber and service related data the PCRF may be aware of by configuration or through the Sp reference point or interface;
pre-configured information in the PCRF.
The Confirmation from OCS

The PCRF shall provision PCC/QoS Rules to the PCEF/BBERF via the Gx/Gxx reference point or interface. Request the credit check for AF controlled service and for services that are requested by the end user via the PCEF node.

Appended OCS Functionality
1. Event Based Charging Function
   The Event Based Charging Function (EBCF) performs event based charging and credit control (e.g. content charging):
      on the bearer level, based on bearer usage requests received from the network. It controls the bearer usage in the network, e.g. SMS;
      on a subsystem level, based on session resource usage requests received from the network (e.g. the IMS MRFC). It controls the resource availability in network, e.g. it has the ability to grant or deny the resource usage;
      on service level, based on application server requests received from the network (e.g. an IMS application server or MMS relay server). It controls the application service availability in the network, e.g. it has the ability to grant or deny the service usage in the network.
   It communicates with the Rating Function in order to determine the value of the requested service usage. It communicates with the Account Balance Management Function to query and update the subscribers' account and counters status (counters are not applicable if a class “B” Rating Function is used).
   When a correlation process is enabled a correlation context may be consulted or created. If multiple chargeable events exist in the correlation context a combined request will be issued for the Rating Function.
2. Session Based Charging Function
   The Session Based Charging Function (SBCF) performs session based charging and credit control:
      on the bearer level, based on bearer usage requests received from the network. It controls the bearer usage in the network, e.g. in terms of time or volume granted;
      on the subsystem level, based on session resource usage requests received from the network (e.g. the IMS CSCF). It controls sessions in the network, e.g. it has the ability to grant or deny a session setup request and to terminate an existing session;
      on the service level, based on service usage requests received from the network. It controls service availability in the network, e.g. it has the ability to grant or deny a usage of a service.
   It communicates with the Rating Function in order to determine the value of the requested bearer resources or the requested session. It communicates with the Account Balance Management Function to query and update the subscribers' account and counters status (counters are not applicable if a class “B” Rating Function is used).
   When a correlation process is enabled a correlation context may be consulted or created. If multiple chargeable events exist in the correlation context, a combined request will be issued for the Rating Function.
3. Rating Function
   The Rating Function performs both monetary and non-monetary unit determination (rating). It provides the following functionalities:
      Rating for network- and external services and applications (session, service, event) before and after service delivery;
      Cross-product and cross-channel discounts, benefits and allowances.
      The Rating Function must be able to handle a wide variety of rateable instances, such as:
      Rating of volume (in terms of granted units or money, e.g. based on charging initiated by an access network entity);
      Rating of time (in terms of granted units or money, e.g. based on charging initiated by a SIP application);
      Rating of events (e.g. based on charging of web content or MMS).
   The Rating Function includes the determination of the tariff or the price of a chargeable event or of multiple chargeable events (correlation scenario); examples include the price of a call minute, data volume, multimedia session, Web content, etc.
   Upon receipt of a rate request (price or tariff request) from the Charging Function, the Rating Function:
      Evaluates the request. Rate requests include various rating parameters such as service identifier, subscriber reference, network identification, user location, service usage time, transferred data volume, etc. Note that the rate request may contain multiple service identifiers that reflect the list of active services contained in the context handled by the Charging Function.
      Determines the applicable price or tariff model and returns it to the Charging Function. Note that in case of multiple service requests received, the Rating Function may apply a special price or tariff which can be different to the price or tariff applied to the related services handled separately. For example when sending an MMS, the rating of volume associated with the bearer usage can be free of charge while the rating of the event and/or volume associated with the service level MMS submission is greater than zero. This correlation procedure depends on the operator configurable rating rules.
   To support the online rating process, the Rating Function needs counters. The counters may be maintained by the Rating Function or by the Account Balance Management function. A Rating Function that does not maintain counters will be marked as class “A” Rating Function. A Rating Function that maintains counters will be marked as class “B” Rating Function.
4. Credit Validation and QoS Validation
   Upon receipt of enquire from PCRF about the Credit validation for the certain users or certain services, OCS shall based on the status of the user's credit availability, user's spending to validate the enquiry from the PCRF.

### ADVANTAGES OF THE INVENTION

The invention has a number of advantages, such as, for example:
By using the invention unnecessary allocation of network resources can be avoided in case insufficient credits are available in the user account.
A lot of unnecessary signaling in EPS/GPRS network as well as the signaling over Gx and Gy can be avoided in case there are insufficient credits available in the user account.
It allows dynamic control for pre-paid based AF controlled services and for services that are requested by the end user via the PCEF node. Some service may be restricted due to the availability of the credit.

### ABBREVIATIONS

The abbreviations used in this text include the following:
3GPP: 3^{rd} Generation Partnership Project
AF: Application Function
APN: Access Point Name
BBERF: Bearer Binding and Event Reporting Function
BSS: Base Station Subsystem
CCR: Credit Control Request
eNB: Evolved NodeB
EPC: Evolved Packet Core
EPS: Evolved Packet System
E-UTRAN: Evolved UTRAN
GBR: Guaranteed Bit Rate
GGSN: Gateway GPRS Support Node
IE: Information Element
IMS: IP Multimedia Subsystem
International Mobile Subscriber Identity
IP-CAN: IP Connectivity Access Network
MME: Mobility Management Entity
QoS: Quality of Service
SGSN: Serving GPRS Support Node
PDN: Packet Data Network
PDN-GW: PDN Gateway
PDP: Packet Data Protocol
PCC: Policy and Charging Control
PCEF: Policy and Charging Enforcement Function
PCRF: Policy and Charging Rules Function
QoS: Quality of Service
UE: User Equipment
UMTS: Universal Mobile Telecommunications System
UTRAN: Universal Terrestrial Radio Access Network

The invention is not limited to the examples of embodiments described above and shown in the drawings, but may be freely varied within the scope of the appended claims.

1. A Policy and Charging Rules Function node, a PCRF node, for a communications system, the PCRF node being characterized in that it is equipped with an interface (Sy) towards an Online Charging System node, an OCS node, in the communications system, and in that the PCRF node is arranged to transmit an inquiry to the OCS over said interface (Sy) regarding a credit validation for a service which has been requested by an end user in the communications system, the PCRF node also being arranged to receive a reply from the OCS to said enquiry.

2. The PCRF node of claim 1, being arranged to receive the request for a service from an end user via a node for Policy and Charging Enforcement Function, a PCEF node, in the system.

3. The PCRF node of claim 1, being arranged to receive the request for a service from an end user via an Application Function, an AF in the system.

4. The PCRF node of claim 2, being arranged to receive said reply from the OCS node as a positive reply which indicates that the end user has sufficient credit for the requested service or as a negative reply which indicates that the end user does not have sufficient credit for the requested service.

5. The PCRF node of claim 2, being arranged to either authorize the service for the end user or to send a reject message for the requested service to the AF or to the PCEF node if the reply from the OCS node is negative.

6. The PCRF node of claim 1, in which the inquiry to the OCS comprises one or more of the following:
The ID of the end user,
The ID of the Packet Data Network, the PDN, of the end user,
The rating group of the requested service,
The ID of the requested service.

7. The PCRF node of claim 1, also being equipped with an interface towards a Policy and Charging Enforcement Function node, a PCEF node, in the system, the PCRF node being arranged to use said interface (Gx) to provide the PCEF node with new or updated Policy and Charging Control, PCC, rules for an end user in the system, based on the received replies from the OCS.

8. An Online Charging System node, an OCS node, in a communications system, the OCS node being characterized in that it is equipped with an interface (Sy) towards a Policy and Charging Rules Function node, a PCRF node in the system, the OCS node being arranged to receive an inquiry from the PCRF node over said interface (Sy) regarding a credit validation for a service which has been requested by an end user in the communications system, the OCS node also being arranged to establish and transmit a reply to the PCRF node to said enquiry.

9. The OCS of claim 8, being arranged to transmit said reply as a positive reply which indicates that the end user has sufficient credit for the requested service or as a negative reply which indicates that the end user does not have sufficient credit for the requested service.
